(19) United States
(12) Patent Application Publication
(10) Pub. No.: US 2019/0101497 A1
(43) Pub. Date: Apr. 4, 2019

(54) DEVICE, SYSTEM AND METHOD FOR MEASURING THERMAL PROPERTIES OF DIFFERENT TYPES OF SHOES

(71) Applicant: THE HONG KONG POLYTECHNIC UNIVERSITY, Hung Hom (HK)

(72) Inventors: Kit-Lun YICK, Hung Hom (HK); Wai-ting LO, Hung Hom (HK); Sun-Pui NG, Hung Hom (HK); Yiu-Wan Joanne YIP, Hung Hom (HK); Annie YU, Hung Hom (HK)

(21) Appl. No.: 15/720,376

(22) Filed: Sep. 29, 2017

(51) Int. Cl. G01N 25/00; A47F 8/00; G01K 7/16

(52) U.S. Cl. CPC G01N 25/00; G01K 7/16; A47F 8/00

(57) ABSTRACT

The present disclosure relates to a device and method for measuring the thermal properties of different types of shoes. More specifically, the present disclosure relates to an improved foot manikin comprising a foot shaped member and a shin element. The foot shaped member is connected to the shin element via an ankle joint. The foot shaped member further comprises a metatarsal phalangeal joint connecting a toe portion of the foot shaped member with the rest of the foot shaped member.

### FIELD

The present disclosure relates generally to a device system and method for measuring thermal properties of different types of shoes.

### BACKGROUND

It is a common experience of persons wearing shoes in various environments that the overall perception of comfort of the shoe is significantly influenced by the thermal properties of that particular shoe as well as the size and style etc. When designing a shoe, the manufacturer can design different types of shoes with different thermal properties depending on the purpose of the shoe and the occasion for which the shoe will be worn.

Some shoes are designed to keep the feet warm while others may be designed to avoid trapping heat, particularly if they only partially enclose the foot. To compare various shoe designs, in addition to subjective data from actual human subjects, it is useful to objectively measure a shoe's thermal properties to evaluate the overall thermal comfort it provides.

Manikins having the shape of a human foot have been developed to allow manufacturers to objectively assess the thermal properties of various shoe designs.

It would be appreciated that as a human foot would be generally warmer compared to the surrounding temperature, manikins typically have heating elements to provide this elevated temperature. Typically, temperature measurements of a shoe on the manikin are taken using sensors in the region between the shoe and the foot manikin to quantitatively study the thermal characteristics of the shoe/foot manikin. Alternatively, an indirect way of measuring the thermal characteristics is by measuring the power provided to the heating element required to maintain the foot manikin surface at a predetermined temperature.

Typically, foot manikins are usually rigid and made of heat conductive metal for creating a uniform temperature over the foot manikin's surface. However, the rigidity of these foot manikins can lead to difficulties in fitting into different types of shoes, e.g. athletic shoes and boots. Further, the heavy weight of these prior art metal foot manikins means it can be somewhat difficult to conduct experiments.

Attempts have been made to more closely simulate the non-uniform variation of temperature on a human foot surface, which has slightly different temperatures at various regions of the foot. In U.S. Pat. No. 6,918,695 there is provided a foot manikin with thermally isolated regions allowing independent control on the temperature of each region. However, these thermally isolated regions are still different from the various temperatures that may be present on a human foot. Further, in this arrangement silicone diaphragms are required to thermally isolate the various regions on the foot manikin and independent electrical supplies have to be connected to each region, resulting in a cumbersome and difficult product to manufacture and use.

The present disclosure is therefore intended to obviate or at least alleviate at least one or more of the problems encountered in prior art.

### SUMMARY

According to a first aspect of the disclosure there is provided a device for measuring the thermal properties of different types of shoes comprising:
a foot shaped member configured for pivotable engagement with another element at an ankle joint, the foot shaped member further comprising at least one or more joints therein,
at least one heating element on a surface of the foot shaped member for generating a predetermined elevated temperature distribution across said surface; and
detection means for measuring the temperature of at least one location proximal the surface of the foot shaped member.

Preferably, the at least one heating element may be configured to simulate a non-uniform gradient temperature distribution of at least one corresponding surface portion of a human foot.

The heating element may comprise at least one or more resistive wires arranged in a predetermined configuration on a carrier element.

A non-uniform gradient temperature distribution may be created across the surface upon which the heating element is located by a corresponding non-uniform distribution of the resistive wires on the carrier element.

The at least one or more joints of the foot shaped member may be disposed at a similar location to a metatarsal phalangeal joint of a human foot.

The device may further comprise a flexible compressible layer for enclosing the foot shaped member and the heating element therein.

Optionally, the layer comprises silicone rubber.

The foot shaped member may comprise a thermoplastic material selected from the group comprising acrylonitrile butadiene styrene, polyethylene or polypropylene.

The device may further comprise a control unit regulating the power supplied to the heating element to maintain the predetermined elevated temperature distribution across said surface of the foot shaped member.

The device may further comprise an apparatus for directing an air current flow about the foot shaped member.

According to a second aspect of the disclosure there is provided a method for measuring the thermal properties of at least one shoe type, the method comprising
attaching a shoe of the at least one type with a foot shaped member configured for pivotable engagement with another element at an ankle joint, the foot shaped member further comprising at least one or more joints therein,
activating at least one heating element on a surface of the foot shaped member to generate a predetermined elevated (gradient) temperature distribution across said surface;
detecting the temperature of at least one location proximal the surface of the foot shaped member.

The at least one heating element may be configured to simulate a non-uniform gradient temperature distribution of at least one corresponding surface portion of a human foot.

The heating element may comprise at least one or more resistive wires arranged in a predetermined configuration on a carrier element

Optionally, a non-uniform gradient temperature distribution may be created across the surface upon which the heating element is located by a corresponding non-uniform distribution of the resistive wires on the carrier element.

The at least one or more joints of the foot shaped member may be disposed at a similar location to a metatarsal phalangeal joint of a human foot

According to a third aspect of the disclosure there is provided a system for measuring the thermal properties of different types of shoes comprising:
a foot shaped member configured for pivotable engagement with another element at an ankle joint, the foot shaped member further comprising at least one or more joints therein,
at least one heating element on a surface of the foot shaped member for generating a predetermined elevated (gradient) temperature distribution across said surface; wherein the heating element comprises at least one or more resistive wires arranged in a predetermined configuration on a carrier element;
detection means for measuring the temperature of at least one location proximal the surface of the foot shaped member,
a control unit regulating the power supplied to the heating element to maintain the predetermined elevated temperature distribution across said surface and
a device for directing an air current flow about the foot shaped member.

Optionally, the at least one heating element may be configured to simulate a non-uniform gradient temperature distribution of at least one corresponding surface portion of a human foot.

The non-uniform gradient temperature distribution may be created across the surface upon which the heating element is located by a corresponding non-uniform distribution of the resistive wires on the carrier element.

The at least one or more joints of the foot shaped member may be disposed at a similar location to a metatarsal phalangeal joint of a human foot.

### BRIEF DESCRIPTION OF THE DRAWINGS

The above features and advantages of the present disclosure will become more apparent from the following detailed description when taken in conjunction with the accompanying drawings:

FIG. 1 is a perspective view of an exemplary foot manikin according to the disclosure herein.

FIGS. 2A-2D depict the fitting of the foot manikin of FIG. 1 into a sports shoe, a high-heel shoe, an oxford shoe and a women's flat shoe respectively.

FIGS. 3A-3B depict two different embodiments of a heating element.

FIG. 4A is a perspective view of the foot manikin of FIG. 1 with heating elements covering the sole, the instep and the heel, and the toes of the foot manikin.

FIG. 4B depicts another heating element configured to at least partially enclose the foot portion of the foot manikin of FIG. 1.

FIG. 5A depicts an exemplary external layer for enclosing the foot manikin of FIG. 1.

FIG. 5B depicts the foot manikin of FIG. 1 in the process of being enclosed by the external layer shown in FIG. 5A.

FIG. 6 is a schematic diagram for an exemplary control and data acquisition system for use with the foot manikin of FIG. 1 in assessing the thermal properties of a shoe.

FIG. 7 depicts an embodiment of a wind tunnel for generating an air current flow around the foot manikin of FIG. 1.

FIGS. 8A-8C depict the temperature distribution on the surface of different types of shoes when worn by a human subject.

FIGS. 9A-9D depict the temperature distribution on various surfaces of a foot manikin assembly comprising the foot manikin of FIG. 1 enclosed by the external layer of FIG. 5A and having a heating element similar to that shown in FIG. 3C in between the foot manikin and the external layer.

FIG. 10 depicts the temperature distribution on the surface of a shoe fitted into the foot manikin assembly of FIGS. 9A-9D.

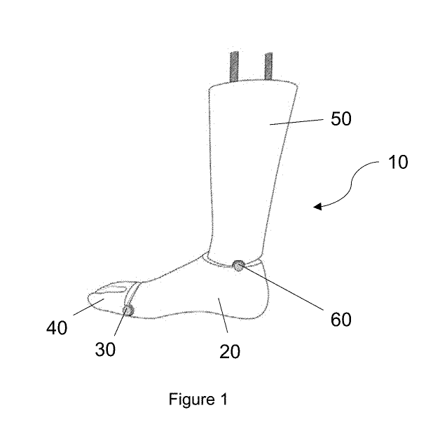

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

In one aspect, the present disclosure provides a foot manikin for measuring the thermal properties of various types of shoes. With reference to the figures, the foot manikin 10 comprises a foot shaped member 20 connected to a shin element 50 via an ankle joint 60. The foot shaped member depicted has a metatarsal phalangeal joint 30 connecting a toe portion 40 of the foot shaped member 20 with the rest of the foot shaped member 20. The ankle joint 60 allows pivotal movement of the foot shaped member 20 relative to the shin element 50 about an axis of the ankle joint 60 resembling the ability of the human foot to move around the ankle. Similarly, the metatarsal phalangeal joint 30 allows pivotal movement of the toe portion 40 relative to the rest of the foot shaped member 20 in a way that resembles toe movement about the metatarsal phalangeal joint of the human foot. The movability of the components of the foot manikin 10 relative to each other allows various types of shoes to be put on the foot manikin with ease, as is explained below.

It would be appreciated that the foot shaped member 20 may be made from any suitable thermoplastic material. The foot shaped member 20 may also be made from other materials depending on the desired properties of the foot member, including weight, rigidity and thermal conductivity. Preferably, the foot shaped member 20 may be made from Acrylonitrile Butadiene Styrene (ABS), Polyethylene (PE) or Polypropylene (PP). Preferably, the foot shaped member 20 is made with a flexible and compressible material for fitting of the foot shaped member 20 into shoes of different shapes and sizes.

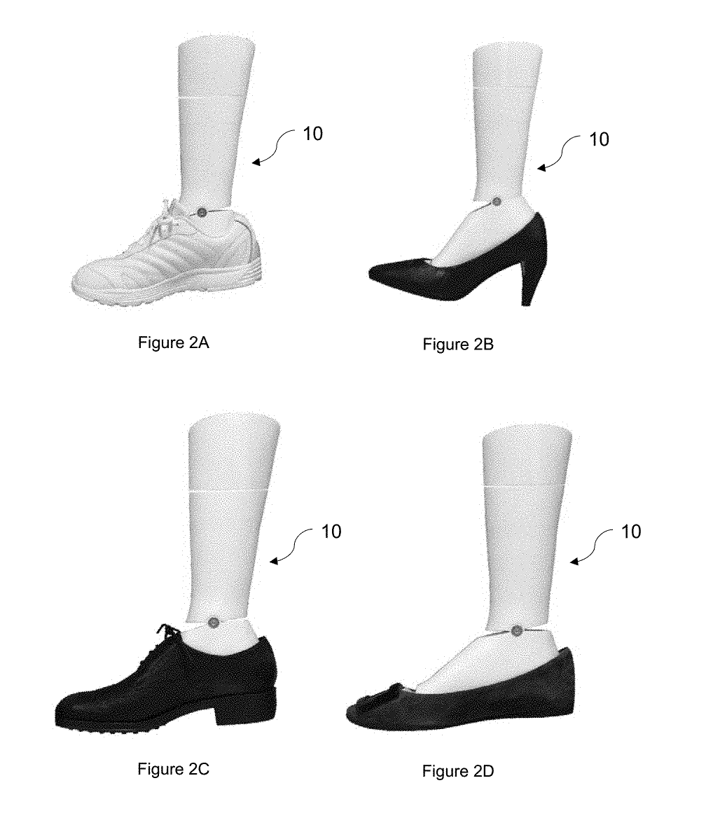

FIGS. 2A to 2D depict the fitting of foot manikin 10 into a sports shoe, a high heel shoe, an oxford shoe and a women's flat shoe. In the foot manikin 10 of the present disclosure, the ankle joint 60 and the metatarsal phalangeal joint 30 allow a certain degree of movement between the toe portion 40 and the rest of the foot shaped member 20, and between the foot shaped member 20 and the shin element 50. This may be contrasted to prior art manikins, which do not allow this ease of fitting.

Due to the capacity for relative movement between the different parts of the foot manikin 10 permitted by the ankle joint 60 and the metatarsal phalangeal joint 30, the foot manikin 10 can be easily fitted into different types of shoes in the same manner as the human foot may be fitted into various shoes. As an example, the foot manikin 10 may be fitted into a high heel shoe and an oxford shoe (as illustrated in FIGS. 2B and 2C). Further, the foot manikin 10 of the present disclosure may be maintained in a foot posture required by a particular type of shoe, e.g. high heel shoes, as exemplified in FIG. 2B.

As discussed above, the foot shaped member 20 is preferably made with a flexible and compressible material. This would be advantageous where the foot manikin is to be fitted to a shoe having a shape different from that of the foot shaped member 20. For example, the women's flat shoe as shown in FIG. 2D has a narrower contour as compared to the foot shaped member 20. Despite such, the foot manikin 10 may still be fitted into such shoes owing to the flexibility of the material used to form the foot shaped member 20.

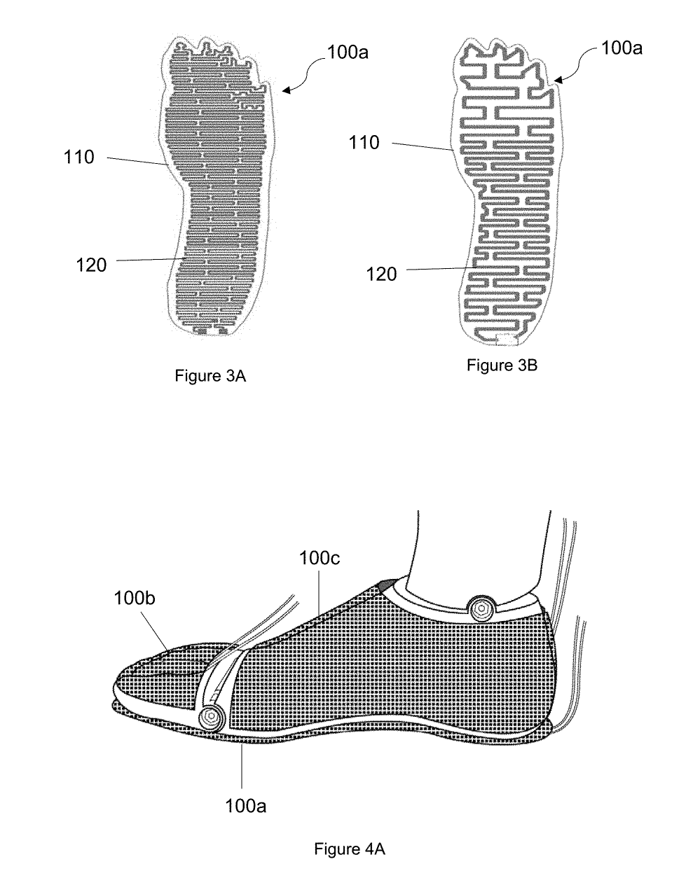

Generally, the temperature of a human foot is warmer than its surrounding environment and therefore a heating means generating an elevated temperature at the surface of the foot shaped member 20 would be required. Referring to FIGS. 3A and 3B, there are shown two exemplary configurations of heating element 100a which may be used with the foot manikin 10. The heating element 100a shown is in the shape of the sole of a human foot and may be attached to the bottom surface of the foot shaped member 20 as shown in FIG. 4A. The heating element 100a comprises a flexible layer of carrier element 110 with resistive wire 120 disposed thereupon. It should be understood that the shape or design of the heating element should not be limited to those described herein and a person skilled in the art could choose a heating element having any particular shape or design without departing from the spirit and scope of the present disclosure.

The resistive wire 120 may take a variety of configurations in which the wire may be uniformly disposed (as illustrated in FIG. 3A) or non-uniformly disposed (as illustrated in FIG. 3B) on the carrier element 110. The resistive wire 120 may be connected to a power source (not shown) for generating an electric current along the resistive wire and thereby warming up the sole shaped heating element 100a together with the bottom surface of the foot shaped member 20 to which the heating element 100a is attached. Where the resistive wire 120 is non-uniformly disposed on the carrier element, a corresponding non-uniform elevated temperature distribution across the bottom surface of the foot shaped member 20 could be created. In a preferred embodiment, the resistive wire 120 is disposed on the carrier element 110 in a predetermined configuration such that the elevated temperature distribution generated across the bottom surface of the foot shaped member 20 simulates the temperature distribution on the sole of a human foot. A person skilled in the art would appreciate that the resistive wire 120 may take any number of configurations according to the desired distribution of temperature on the surface of the foot shaped member 20 to be achieved.

As illustrated in FIG. 4A, a heating elements 100b and 100c may also be provided on the surface of the foot shaped member 20 such that the heating elements 100a, 100b and 100c substantially cover the whole surface of the foot shaped member 20. Resistive wires (not shown) are disposed on the heating elements 100b and 100c in a pre-determined configuration such that the elevated temperature distribution created on the surface of the foot shaped member 20 covered by the heating elements 100b and 100c simulates the non-uniform temperature distribution on the corresponding surface of a human foot.

In an alternative embodiment shown in FIG. 4B, another heating element 100d comprises the sole-shaped carrier element 110 with flaps 180, 182 and 184 attached to the carrier element 110. Resistive wire 120 is non-uniformly disposed on the carrier element 110 and flaps 180, 182 and 184. The flaps 180, 182 and 184 are flexible and are foldably attached to the carrier element 110. The foot shaped member 20 may be placed on the carrier element 110 and the flaps 180, 182 and 184 may be folded to at least partially enclose the foot shaped member 20. Upon connecting the resistive wire 120 to a power source, a non-uniform elevated gradient temperature distribution would be created across the surface of the foot shaped member 20 that is covered by the heating element 100d. In a preferred embodiment, the resistive wire 120 is disposed on the carrier element 110 and on the flaps 180, 182 and 184 in a predetermined configuration such that the elevated temperature distribution generated across the surface of the foot shaped member 20 simulates the temperature distribution on a human foot.

It would be appreciated that the temperature distribution on the surface of a human foot may vary between different populations and is dependent on a number of factors such as the subject's age, gender, lifestyle and health. To cater for such difference, the resistive wire of the present disclosure may be arranged on or in the carrier element in a variety of non-uniform configurations. A higher density of resistive wire may be arranged at a position where a higher surface temperature is found on a corresponding position of the foot of a target population group, and vice versa. As such, an elevated temperature distribution on the surface of the foot shaped member 20 matching with the non-uniform gradient temperature distribution found on the foot of the target population group may be generated. In addition, as the non-uniform gradient temperature distribution is created by variations in the density of the resistive wire disposed on the carrier element, the non-uniform gradient temperature distribution so created does not suffer from any abrupt change of temperature between two proximal points as would be found in the case of a foot manikin divided into different temperature zones by insulating membranes.

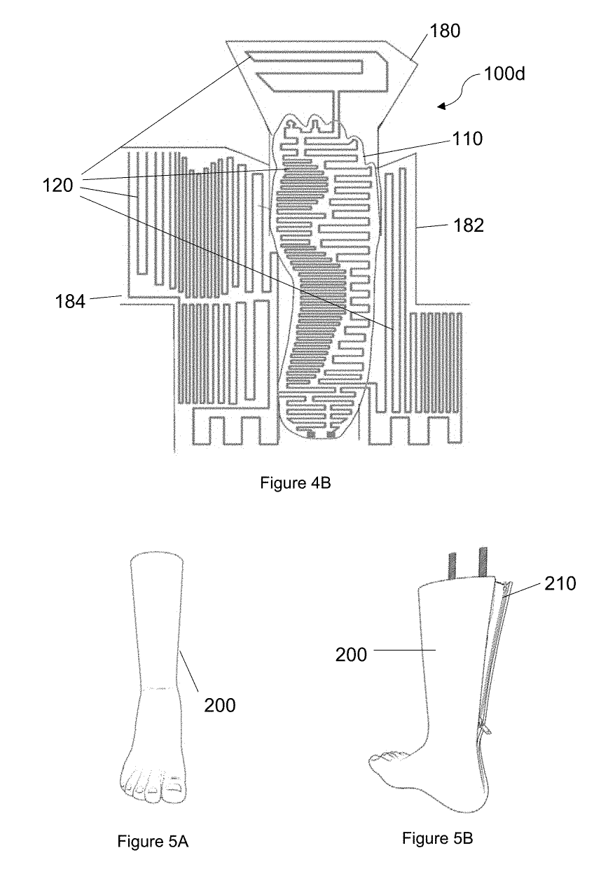

In a further aspect of an exemplary embodiment, an external layer 200 as shown in FIG. 5A is provided for enclosing the foot manikin 10 and the heating elements 100a, 100b, 100c or 100d. The external layer 200 is preferably flexible and compressible giving a texture resembling that of a human skin. In a preferred embodiment, the external layer 200 is made from silicone rubber. A zipper 210 is provided at the back of the external layer 200 to allow the back portion of the external layer 200 to be opened for foot manikin 10 and the heating elements 100a, 100b, 100c or 100d to be placed therein, as illustrated in FIG. 5B.

In an experiment for measuring the thermal properties of a specific shoe type selected from various different types of shoes, the available shoe to be tested is attached to the external layer 200 enclosing the foot manikin 10 and at least one of the heating elements 100a, 100b, 100c and 100d. Upon activation of the heating element(s), a predetermined elevated temperature distribution across a surface of the foot shaped member 20 is created. Temperature sensors, for example thermistor, thermocouple, resistive temperature detectors or infrared thermal detectors may be provided to monitor the temperature at a location proximal the surface of the foot shaped member 20. The thermal properties of the shoe being tested may be assessed by measuring the rate of heat lost from the surface of the foot shaped member 20, or the amount of power required to be supplied to the heating element(s) to maintain the predetermined elevated temperature distribution across the surface of the foot shaped member 20.

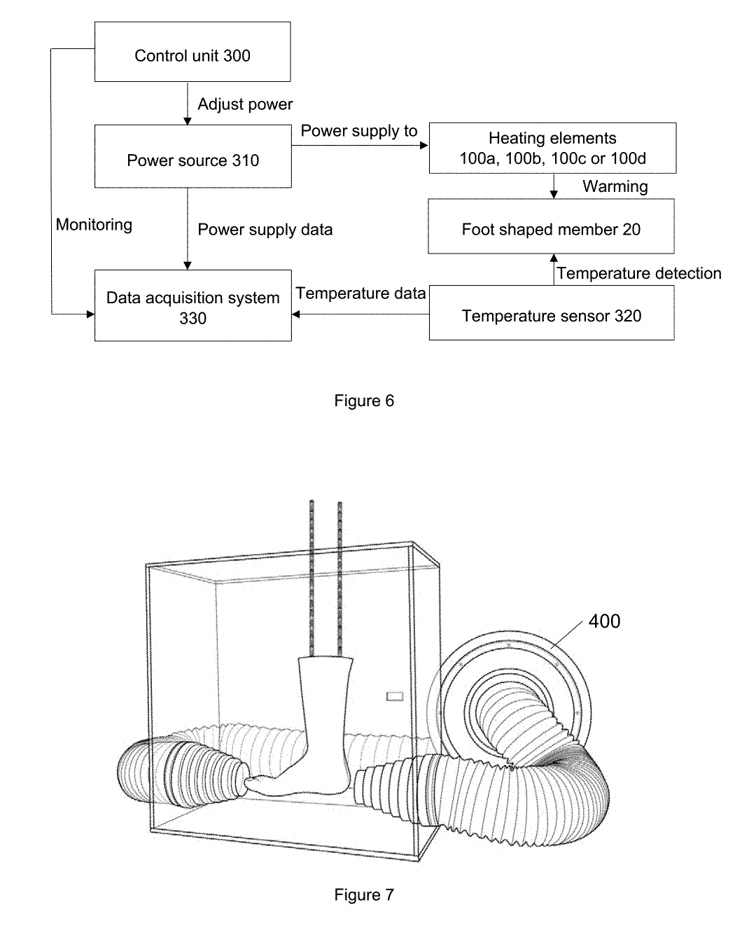

FIG. 6 provides a schematic illustration of a control system for use in the aforementioned experiment. The system comprises a power source 310 linked to a control unit 300. The power source 310 is connected to the heating elements 100a, 100b, 100c or 100d for creating a predetermined elevated temperature distribution across the surface of the foot shaped member 20 covered by these heating elements. Sensing of the temperature at the surface of the foot shaped member 20 may be achieved by a temperature sensor 320, for example a thermistor, thermocouple, resistive temperature detectors or infrared thermal detector. The power supplied by the power source 310 and the temperature data from the temperature sensor 320 may be recorded in a data acquisition system 330. The control unit 300 continuously monitor the temperature readings sent to the data acquisition system 330 and adjust the power supplied by the power source 310 to the heating element(s) to maintain the predetermined elevated temperature distribution.

In a further embodiment, the system for measuring the thermal properties of a shoes selected from various different types of shoes may further include an apparatus 400 for directing an air current about the shoes. The relative movement between the air and the shoe is aimed to simulate a situation wherein a human foot wearing the shoe moves relative to its environment. This allows for the study on the thermal properties of the shoes when the person wearing the shoe is engaged in various kind of activities, e.g. walking, jogging or running. In a preferred embodiment, the system may further encompass an air flow sensor for measuring the speed of the air current at a location proximal to the shoe.

### EXAMPLE 1

Thermal Properties of Shoes Tested on Human Feet

The thermal properties of a pair of closed toe slipper, a first pair of sports shoes and a second pair of sports shoes having a mesh-like surface were tested. The shoes were worn by a human subject and infrared thermal images of the shoes were taken in a walking test at 3 km/h after 30 minutes of walking.

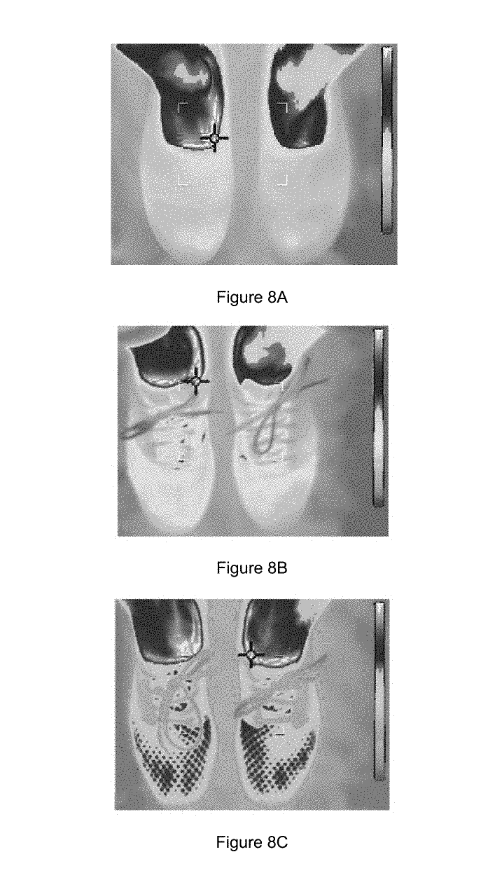

The results for the pair of closed toe slipper and the first and second pair of sports shoes are shown respectively in FIGS. 8A-8C. Regions with a higher temperature are represented by a darker colour. A darker colour at the surface of the shoe represents better thermal conductivity at that region of the shoes demonstrating heat transfer from the human foot to the surface of the shoe and thus increasing the apparent detected temperature.

As seen from the infrared thermal images, the second pair of sports shoes has the best thermal conductivity, probably due to its mesh surface which assists in ventilation of the human feet. Shoes with high thermal conductivity are good at dissipating heat from the feet during exercise and keeping the foot cool in hot weather. On the other hand, the closed toe slipper is the best thermal insulator and would be useful for keep the foot warm in cold weather.

### EXAMPLE 2

Temperature Distribution on Foot Manikin Assembly

A foot manikin assembly was constructed using the foot manikin 10, a variation of the heating element 100d (wherein the configuration of the resistive wire 120 is modified) and the external layer 200. The external layer 200 enclosed the foot manikin 10. The heating element, at least partially covering the surface of foot shaped member 20, was sandwiched between the external layer and the foot manikin 10.

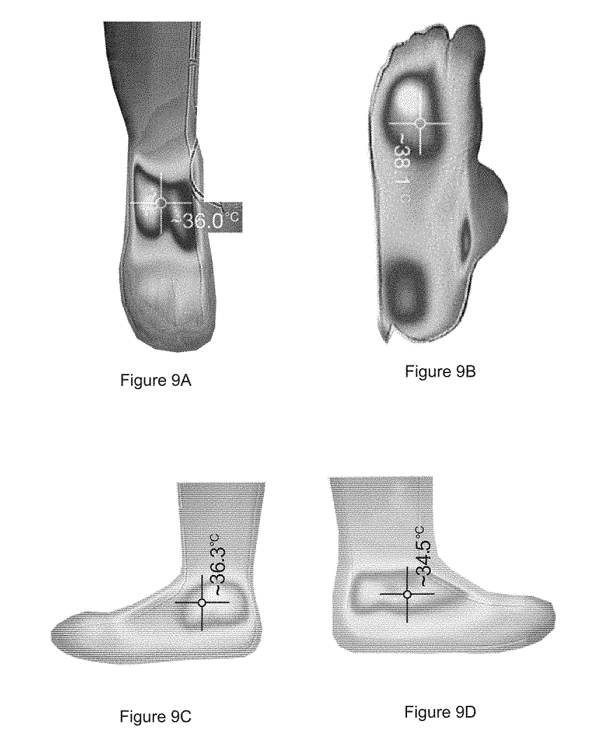

A direct current power source of 10-20V was connected to the resistive wire 120 of the heating element. Infrared thermal images of the foot manikin assembly were taken 5 minutes after the power source was collected. FIGS. 9A-9D show the infrared thermal images of various surfaces of the foot manikin assembly. A non-uniform elevated gradient temperature distribution on the surface of the foot manikin assembly matching with the non-uniform configuration of the resistive wire was observed in the infrared images. A higher surface temperature on the foot manikin assembly was observed in regions where a higher density of the resistive wire was disposed. As the resistive wire takes a gradual change in its density on the heating element, a smooth temperature transition represented by the gradual change in the grayscale tones in FIGS. 9A-9D was observed between different regions on the surface of the foot manikin assembly. The temperatures on the manikin assembly surface accordingly resembles the temperature distribution that would be found on a human foot. Thus the foot manikin assembly may be used as a model tool for stimulation of the surface temperature on a human foot.

### EXAMPLE 3

Thermal Properties of Shoes Tested With Foot Manikin Assembly

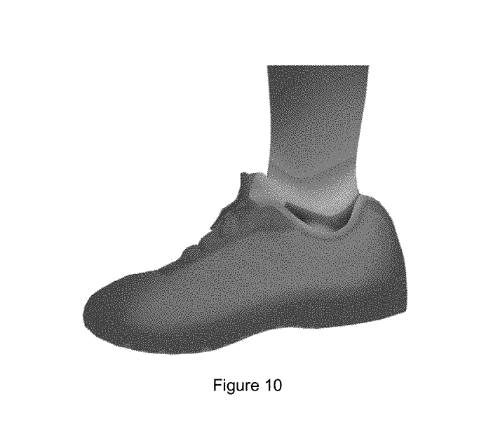

A sports shoe was fitted to the foot manikin assembly of Example 2. A direct current power source of 10-20V was connected to the resistive wire and infrared thermal images of the foot manikin assembly with the sports shoe were taken after 5 minutes. The infrared image is shown in FIG. 10. The thermal properties of the shoe may be evaluated by assessing the temperature on the surface of the shoe, as described in Example 1.

It would be appreciated that the original infrared thermal images referred to in the above examples were obtained in colour but are reproduced in the present disclosure in grayscale. While the original thermal image uses a scale from red to blue to represent different temperatures, the compression of such colour information into grayscale may result in some loss of information and as a result the gradient temperature transition in the grayscale figures may not be as clear as that in the original colour image. Nevertheless, a skilled person in the art would still appreciate that the device of the present disclosure is capable of generating a non-uniform elevated temperature distribution similar to that found on the surface of human foot.

The foot manikin of the present disclosure is significantly lighter than prior art manikins which enables easier manipulation. Furthermore, the foot manikin may be made from a flexible and compressible material and equipped with joints which functionally reproduce the ankle joint and metatarsal phalangeal joint of the human foot. Such design allows easy fitting of the foot manikin into various types of shoes, including sports shoe, high-heel shoe, oxford shoe and women's flat shoe.

Different forms of heating element may be provided for creating an elevated temperature on the surface of the foot manikin. The resistive wire disposed on the heating element may have various configurations and may be non-uniformly arranged on the heating element. The resistive wire may be configured to generate a gradient temperature distribution on the manikin surface that resembles the temperature distribution on the surface of a human foot.

The foot manikin allows for objective measurement of the thermal properties of a particular shoe type of the many shoe types available. With the interchangeable heating element and variable resistive wire configuration, simulation of the temperature distribution on the foot of a particular human subject selected from any age group and gender is possible, in a wide variety of different shoe types, without requiring different manikins or a variety of manikins.

Although the present disclosure has been explained by way of the examples described above, it should be understood to the ordinary skilled person in the art that the disclosure is not limited to the examples, but rather that various changes or modifications thereof are possible without departing from the disclosure.

1. A device for measuring the thermal properties of different types of shoes comprising:
a foot shaped member configured for pivotable engagement with another element at an ankle joint, the foot shaped member further comprising at least one or more joints therein,
at least one heating element on a surface of the foot shaped member for generating a predetermined elevated temperature distribution across said surface; and
detection means for measuring the temperature of at least one location proximal the surface of the foot shaped member.

2. The device of claim 1, wherein the at least one heating element is configured to simulate a non-uniform gradient temperature distribution of at least one corresponding surface portion of a human foot.

3. The device of claim 1, wherein the heating element comprises at least one or more resistive wires arranged in a predetermined configuration on a carrier element.

4. The device of claim 3, wherein a non-uniform gradient temperature distribution is created across the surface upon which the heating element is located by a corresponding non-uniform distribution of the resistive wires on the carrier element.

5. The device of claim 1, wherein the at least one or more joints of the foot shaped member is disposed at a similar location to a metatarsal phalangeal joint of a human foot.

6. The device of claim 1, further comprising a flexible compressible layer for enclosing the foot shaped member and the heating element therein.

7. The device of claim 6, wherein the layer comprises silicone rubber.

8. The device of claim 1, wherein the foot shaped member comprises a thermoplastic material selected from the group comprising acrylonitrile butadiene styrene, polyethylene or polypropylene.

9. The device of claim 1, further comprising a control unit regulating the power supplied to the heating element to maintain the predetermined elevated temperature distribution across said surface of the foot shaped member.

10. The device of claim 1, further comprising an apparatus for directing an air current flow about the foot shaped member.

11. A method for measuring the thermal properties of at least one shoe type, the method comprising
attaching a shoe of the at least one type with a foot shaped member configured for pivotable engagement with another element at an ankle joint, the foot shaped member further comprising at least one or more joints therein,
activating at least one heating element on a surface of the foot shaped member to generate a predetermined elevated (gradient) temperature distribution across said surface;
detecting the temperature of at least one location proximal the surface of the foot shaped member.

12. The method of claim 11, wherein the at least one heating element is configured to simulate a non-uniform gradient temperature distribution of at least one corresponding surface portion of a human foot.

13. The method of claim 11, wherein the heating element comprises at least one or more resistive wires arranged in a predetermined configuration on a carrier element

14. The method of claim 13, wherein a non-uniform gradient temperature distribution is created across the surface upon which the heating element is located by a corresponding non-uniform distribution of the resistive wires on the carrier element.

15. The method of claim 11, wherein the at least one or more joints of the foot shaped member is disposed at a similar location to a metatarsal phalangeal joint of a human foot

16. A system for measuring the thermal properties of different types of shoes comprising:
a foot shaped member configured for pivotable engagement with another element at an ankle joint, the foot shaped member further comprising at least one or more joints therein,
at least one heating element on a surface of the foot shaped member for generating a predetermined elevated (gradient) temperature distribution across said surface; wherein the heating element comprises at least one or more resistive wires arranged in a predetermined configuration on a carrier element;
detection means for measuring the temperature of at least one location proximal the surface of the foot shaped member,
a control unit regulating the power supplied to the heating element to maintain the predetermined elevated temperature distribution across said surface and
a device for directing an air current flow about the foot shaped member.

17. The system of claim 16, wherein the at least one heating element is configured to simulate a non-uniform gradient temperature distribution of at least one corresponding surface portion of a human foot.

18. The system of claim 17, wherein the non-uniform gradient temperature distribution is created across the surface upon which the heating element is located by a corresponding non-uniform distribution of the resistive wires on the carrier element.

19. The system of claim 16, wherein the at least one or more joints of the foot shaped member is disposed at a similar location to a metatarsal phalangeal joint of a human foot.
